(19) United States
(12) Patent Application Publication
(10) Pub. No.: US 2009/0315924 A1
(43) Pub. Date: Dec. 24, 2009

(54) METHOD AND SYSTEM FOR ADJUSTING SCREEN RESOLUTION

(75) Inventor: PO-YEN CHOU, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignee: CHI MEI COMMUNICATION SYSTEMS, INC., Tu-Cheng City (TW)

(21) Appl. No.: 12/328,781

(22) Filed: Dec. 5, 2008

(30) Foreign Application Priority Data
Jun. 19, 2008 (CN) 200810302212.X

(51) Int. Cl. G09G 5/02

(52) U.S. Cl. 345/698

(57) ABSTRACT

A method and system for adjusting screen resolution of a display panel of an electronic device are provided. The method includes defining a mapping table indicative of a suitable screen resolution with respect to a plurality of distance ranges between the electronic device and a user in front of the electronic device, and adjusting the screen resolution of the display panel according to a distance between the electronic device and the user accordingly.

### BACKGROUND

1. Field of the Invention

Embodiments of the present disclosure relate to screen resolution adjustment, and more particularly to a method and a system for adjusting screen resolution on a portable electronic device.

2. Description of related art

Today computer display devices have a wide range of available screen resolutions. Some of the standard resolutions are 640*480, 800*600, 1024*768, and 1152*768. Each of these resolutions gives the number of pixels that are displayed in the width and height of the display area. For example the 640*480 resolution displays 640 pixels across the width of the display and 480 pixels across the height of the display. These screen resolutions can typically be changed by the user by adjusting the display driver.

However, as the distance between the display devices and the user in front of the display devices varies, the display devices are not able to provide satisfactory visual performance with the fixed screen resolution.

Accordingly, a method and a system for adjusting screen resolution of a display panel are called for in order to overcome the limitations described.

### BRIEF DESCRIPTION OF THE DRAWINGS

FIG. 1 is a block diagram of an embodiment of a system for adjusting the screen resolution of a display panel;

FIG. 2 is an isometric view of an electronic device according to the embodiment;

FIG. 3 shows an illustrated example of the mapping table indicative of the suitable screen resolutions of the display panel; and

FIG. 4 is a flowchart of an embodiment of a method for adjusting the screen resolution of the display panel.

### DETAILED DESCRIPTION OF CERTAIN INVENTIVE EMBODIMENTS

All of the processes described may be embodied in, and fully automated via, software code modules executed by one or more general purpose computers or processors. The code modules may be stored in any type of computer-readable medium or other storage device. Some or all of the methods may alternatively be embodied in specialized computer hardware or communication apparatus.

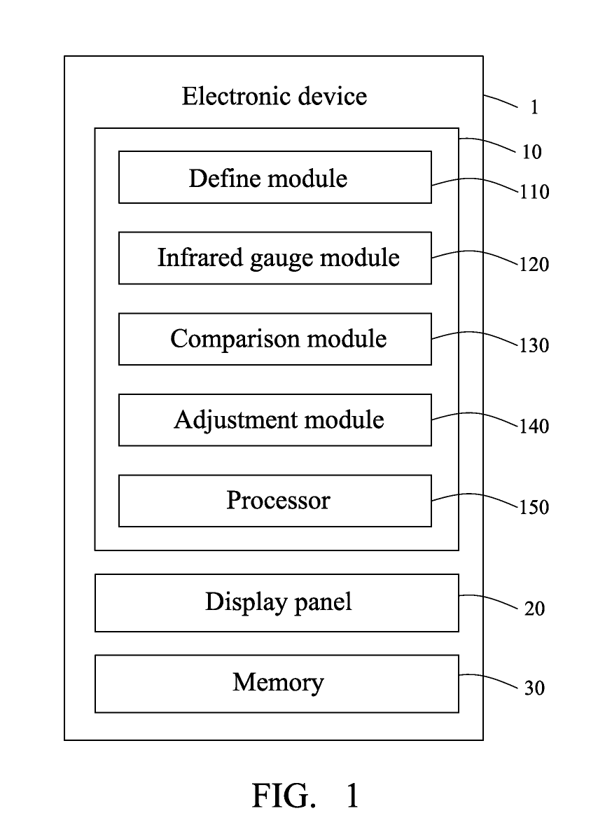

FIG. 1 is a block diagram of an embodiment of a system 10 for adjusting a screen resolution of a display panel 20 (hereinafter “the system 10”). The system 10 includes a define module 110, an infrared gauge module 120 having an infrared unit 122, a comparison module 130, an adjustment module 140, and a processor 150 for executing the above modules, in addition to other hardware and software components of the electronic device 1.

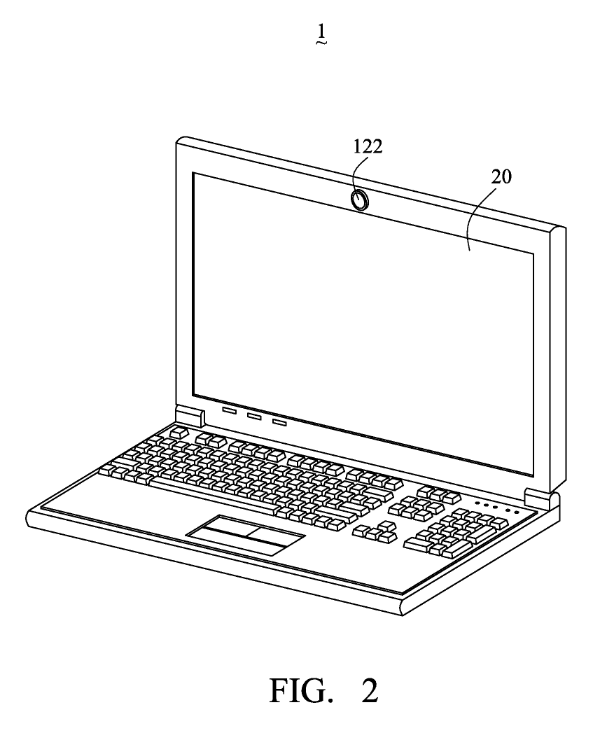

With reference to FIG. 1 and FIG. 2, the electronic device 1, such as a notebook, includes the display panel 20, the system 10 for adjusting the screen resolution of the display panel 20, and a memory 30 for storing program instructions that are executed by, and data that are used and processed by, the processor 150 to perform the functions of the present disclosure. The memory 30 may include electronic memory devices, such as random-access memory (RAM), read-only memory (ROM), etc., and electro-mechanical memory, such as magnetic disk drives, tape drives, etc., which may use an integrated drive electronics (IDE) interface, or a variation or enhancement thereof.

The infrared unit 122 is arranged in proximity of the display panel 20 and is configured for sending a predetermined infrared ray to a user in front of the display panel 20 of the electronic device 1. In other embodiments, the electronic device 1 may be, a desktop computer, a server, or other device, without departing from the spirit of the disclosure.

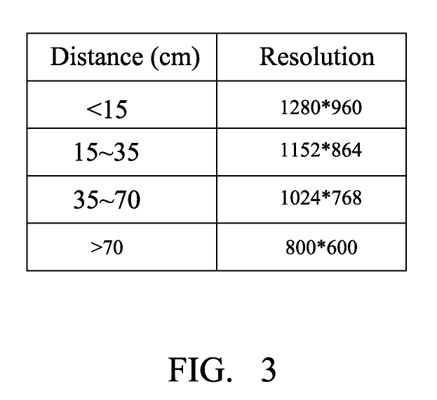

The define module 110 is configured for defining a mapping table indicative of the suitable screen resolution with respect to a plurality of distance ranges between the user and the electronic device 1. FIG. 3 shows an illustrated example of the mapping table. For example, if the physical distance between the user and the electronic device 1 (hereinafter referred to as “physical distance”) is less than 15 centimeters (cm), the suitable screen resolution is defined as 1280*960. Upon the define module 110 determines the physical distance is greater than 70 cm, the suitable screen resolution is defined as 800*600.

The infrared gauge module 120 is configured for calculating the physical distance for a predetermined time interval. The value of the predetermined time interval is defined by the define module 110. For example, the infrared gauge module 120 calculates the physical distance for every 30 seconds if the predetermined time interval is defined as 30 seconds.

In the embodiment, the infrared unit 122 of the infrared gauge module 120 is for sending the predetermined infrared ray, and receiving the infrared ray reflected from the user in front of the display panel 20. Upon receiving the reflected infrared ray, the infrared gauge module 120 counts a round trip time of the infrared ray so as to calculate the physical distance.

The comparison module 130 is configured for detecting the current screen resolution of the display panel 20 and generating an adjustment notification in response to a determined incompatibility of the screen resolution according to the detected screen resolution, the calculated physical distance from the infrared gauge module 120, and the suitable screen resolution of the mapping table.

For example, according to the mapping table of FIG. 3, if the calculated physical distance is 30 cm, the suitable screen resolution is defined as 1152*864. Upon determining that the detected screen resolution is less than the suitable screen resolution, the adjustment notification indicates that a higher screen resolution than the detected screen resolution is required. In the embodiment, the adjustment module 140 adjusts the screen resolution of the display panel 20 to a higher resolution than the detected screen resolution according to the adjustment notification.

In addition, upon determining that the detected screen resolution is greater than the suitable screen resolution, the adjustment notification indicates that a lower screen resolution than the detected screen resolution is required. Accordingly, the adjustment module 140 adjusts the screen resolution of the display panel 20 to a lower resolution than the detected screen resolution according to the adjustment notification.

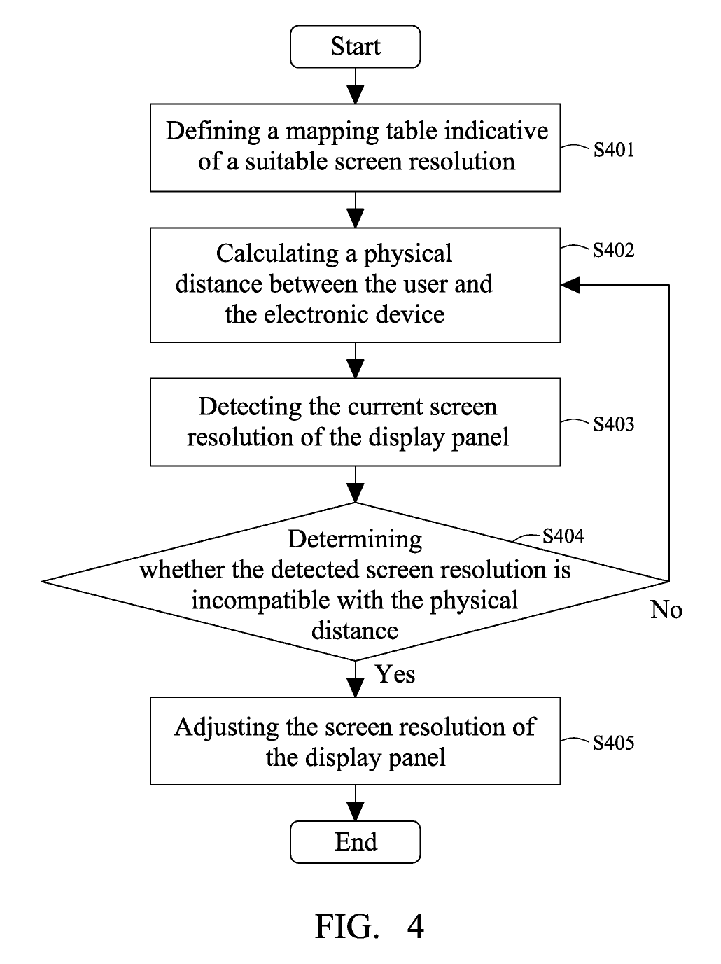

FIG. 4 is a flowchart of an embodiment of a method for adjusting the screen resolution of the display panel 20. The method of FIG. 4 may used for adjusting the screen resolution of the display panel 20 according to the physical distance between a user and the electronic device 1. Depending on the embodiment, additional blocks may be added or deleted and the blocks may be executed in order other than that described.

In block S401, the define module 110 defines a mapping table indicative of a suitable screen resolution with respect to a plurality of distance ranges between the electronic device 1 and the user in front of the electronic device. In block S402, the infrared gauge module 120 calculates a physical distance between the user and the electronic device 1. It is to be noted that the physical distance is calculated by sending a predetermined infrared ray, receiving the infrared ray reflected from the user in front of the display panel 20 of the electronic device 1, and counting a round trip time of the infrared ray.

In block S403, the comparison module 130 detects the current screen resolution of the display panel 20. In block S404, the comparison module 130 determines whether the detected screen resolution is incompatible with the physical distance, and generates an adjustment notification accordingly.

If an incompatibility is determined in S404, in block S405, the adjustment module 140 adjusts the screen resolution of the display panel 20 in response to the adjustment notification. Otherwise, the process goes back to block S402 to repeat the above-mentioned processing.

It is important to note that while the disclosure has been described in the context of a fully functioning data processing system, those of ordinary skill in the art will appreciate that the processes of the disclosure are capable of being distributed in the form of a computer readable medium of instructions and a variety of forms and that the disclosure applies equally regardless of the particular type of signal bearing media actually used to carry out the distribution. Examples of computer readable media include recordable-type media such as floppy disc, a hard disk drive, RAM, and compact disc-read only memory (CD-ROM), as well as transmission-type media, such as digital and analog communications links.

It should be emphasized that the described inventive embodiments are merely possible examples of implementations, and set forth for a clear understanding of the principles of the present disclosure. Many variations and modifications may be made to the above-described inventive embodiments without departing substantially from the spirit and principles of the present disclosure. All such modifications and variations are intended to be included herein within the scope of this disclosure and the above-described inventive embodiments, and the present disclosure is protected by the following claims.

What is claimed is:

1. A system for adjusting a screen resolution of a display panel of an electronic device, the system comprising:
a define module configured for defining a mapping table indicative of a suitable screen resolution with respect to a plurality of distance ranges between the electronic device and a user in front of the electronic device;
an infrared gauge module configured for calculating a physical distance between the user and the electronic device;
a comparison module configured for detecting the current screen resolution of the display panel, and generating an adjustment notification indicative of an adjustment to the screen resolution in response to a determined incompatibility of the screen resolution according to the calculated physical distance, the detected screen resolution and the mapping table; and
an adjustment module configured for adjusting the screen resolution of the display panel in response to the adjustment notification.

2. The system as claimed in claim 1, wherein the infrared gauge module comprises an infrared unit for sending a predetermined infrared ray, receiving the infrared ray reflected from the user in front of the display panel of the electronic device, calculating a round trip time of the infrared ray so as to calculate the physical distance between the electronic device and the user.

3. The system as claimed in claim 2, wherein the infrared gauge module is configured for calculating the physical distance between the electronic device and the user for a predetermined time interval.

4. The system as claimed in claim 3, wherein the value of the predetermined time interval is defined by the define module.

5. The system as claimed in claim 2, wherein the adjustment module adjusts the screen resolution of the display panel to a higher resolution than the detected screen resolution in response to a determination that the detected screen resolution of the display panel is less than the suitable screen resolution of the mapping table corresponding to the detected physical distance.

6. The system as claimed in claim 2, wherein the adjustment module adjusts the screen resolution of the display panel to a lower resolution than the determined current resolution in response to a determination that the screen resolution of the display panel is greater than the suitable screen resolution of the mapping table corresponding to the detected physical distance.

7. A computer-implemented method for adjusting a screen resolution of a display panel of an electronic device, the method comprising:
defining a mapping table indicative of a suitable screen resolution with respect to a plurality of distance ranges between the electronic device and a user in front of the electronic device;
calculating a physical distance between a user and the electronic device;
detecting the current screen resolution of the display panel;
generating an adjustment notification indicative of an adjustment to the screen resolution in response to a determined incompatibility of the screen resolution according to the calculated physical distance, the detected screen resolution and the corresponding distance ranges of the mapping table; and
adjusting the screen resolution of the display panel in response to the adjustment notification.

8. The computer-implemented method as claimed in claim 8, wherein the calculating the physical distance between the electronic device and the user further comprises:
sending a predetermined infrared ray;
receiving the infrared ray reflected from the user in front of the display panel of the electronic device; and
counting a round trip time of the infrared ray so as to calculate the physical distance between the electronic device and the user.

9. The computer-implemented method as claimed in claim 8, wherein the method further comprises calculating the physical distance between the electronic device and the user for a predetermined time interval.

10. The computer-implemented method as claimed in claim 8, wherein the adjusting the screen resolution of the display panel further comprises:
adjusting the screen resolution of the display panel to a higher resolution than the detected screen resolution in response to a determination that the detected screen resolution of the display panel is less than the suitable screen resolution of the mapping table corresponding to the detected physical distance.

11. The computer-implemented method as claimed in claim 8, wherein the adjusting the screen resolution of the display panel further comprises:
adjusting the screen resolution of the display panel to a lower resolution than the detected screen resolution in response to a determination that the detected screen resolution of the display panel is greater than the suitable screen resolution of the mapping table corresponding to the detected physical distance.

12. A computer-readable medium for adjusting a screen resolution of a display panel of an electronic device, the computer-readable medium having stored thereon instructions that, when executed by the electronic device, cause the electronic device to:
define a mapping table indicative of a suitable screen resolution with respect to a plurality of distance ranges between the electronic device and a user in front of the electronic device;
calculate a physical distance between a user and the electronic device;
detect the current screen resolution of the display panel;
generate an adjustment notification indicative of an adjustment to the screen resolution in response to a determined incompatibility of the screen resolution according to the calculated physical distance, the detected screen resolution and the corresponding distance ranges of the mapping table; and
adjust the screen resolution of the display panel in response to the adjustment notification.

13. The computer-readable medium as claimed in claim 12, wherein the calculating the physical distance between the electronic device and the user further comprises:
send a predetermined infrared ray;
receive the infrared ray reflected from the user in front of the display panel of the electronic device; and
count a round trip time of the infrared ray so as to calculate the physical distance between the electronic device and the user.

14. The computer-readable medium as claimed in claim 12, wherein the instructions further cause the electronic device to calculate the physical distance between the electronic device and the user for a predetermined time interval.

15. The computer-readable medium as claimed in claim 12, wherein the adjusting the screen resolution of the display panel further comprises:
adjust the screen resolution of the display panel to a higher resolution than the detected screen resolution in response to a determination that the detected screen resolution of the display panel is less than the suitable screen resolution of the mapping table corresponding to the detected physical distance.

16. The computer-readable medium as claimed in claim 12, wherein the adjusting the screen resolution of the display panel further comprises:
adjust the screen resolution of the display panel to a lower resolution than the detected screen resolution in response to a determination that the detected screen resolution of the display panel is greater than the suitable screen resolution of the mapping table corresponding to the detected physical distance.
